(19) United States
(12) Patent Application Publication
(10) Pub. No.: US 2014/0281413 A1
(43) Pub. Date: Sep. 18, 2014

(54) Superforwarding Processor

(71) Applicant: MIPS TECHNOLOGIES, INC., Sunnyvale, CA (US)

(72) Inventors: Qian WANG, Santa Clara, CA (US); Ranganathan Sudhakar, Santa Clara, CA (US)

(73) Assignee: MIPS Technologies, Inc., Sunnyvale, CA (US)

(21) Appl. No.: 13/828,747

(22) Filed: Mar. 14, 2013

(51) Int. Cl. G06F 9/30

(52) U.S. Cl. CPC G06F 9/30098
USPC 712/217; 712/226

(57) ABSTRACT

Methods and systems that allow the processor to effectively and efficiently reduce or eliminate the latency associated with instructions that copy the value of one register to another register. A processor includes a superforwarding table, a superforwarding logic block, and a computation engine. The superforwarding table stores an entry, wherein the entry has a valid bit, a key field, and a forward field. The superforwarding logic block determines which register contains the information needed for an instruction. The computation engine executes instructions.

### BACKGROUND

1. Field of the Invention

The invention is generally related to systems and methods for increasing the efficiency of instruction execution. More specifically, the disclosure is related to identifying register-to-register (RtR) transfer instructions and eliminating the latency caused by RtR transfer instructions by forwarding the source information to instructions using the destinations of the RtR transfer instructions.

2. Related Art

Processor designers are continually attempting to improve the performance of processors. Performance can be measured in many different ways. For example, processor designers may increase the speed of the processors by increasing the number of instructions in the processor can complete in a given time period, e.g., in one second. In order to increase the speed that processors can execute instructions that comprise applications, processor designers have implemented many ways in which instructions can be executed at substantially the same time and in various orders.

An instruction cannot begin execution until the processor knows the values of the registers needed to execute the instruction. For example, an instruction to be sent to the processor may be “add r4, r5, 0x8” that takes the value in r5 (a source register), adds 8 to it, and stores the result in r4 (the destination register). Therefore, the processor needs to know the value of r5 before it can execute this instruction. Thus, the processor will not start executing the instruction add r4, r5, 0x8 if a previous instruction that changes the value of r5 is still determining the value of r5. Thus, each instruction must wait for any previous instructions that affect the value of its source registers to execute, before the processor can indicate that the instruction is ready to be executed.

### BRIEF SUMMARY OF THE INVENTION

What is needed therefore, are systems and methods that allow the processor to effectively and efficiently remove some or all of the latency related to instructions that merely copy the value of one register to another register by modifying any instructions depending on the destination of this copy instruction to use the values in the source register.

According to embodiments of the invention, a method of comparing a value of a source register for an instruction against a key for each valid entry in a superforwarding table and modifying the instruction by replacing the value of the source register with a value in a forwarding register if the source register matches the key for a valid entry in the superforwarding table is presented. The method includes modifying a future instruction using a register renaming table.

Embodiments of the invention include a processor. The processor includes a superforwarding table, a superforwarding logic block and a computation engine. The superforwarding table stores an entry, wherein the entry has a valid bit, a key, and a forward field. The superforwarding logic block determines which register contains the information needed for an instruction. The computation engine executes instructions.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 depicts a block diagram of a general superforwarding system for updating the superforwarding table, according to various embodiments of the invention.

FIG. 2 depicts a block diagram of a general superforwarding system for modifying instructions, according to various embodiments of the invention.

FIG. 3 illustrates a method of modifying instructions according to various embodiments of the invention.

FIG. 4 depicts an exemplary diagram of a general superforwarding system, according to various embodiments of the invention.

FIG. 5 depicts a block diagram of a superforwarding system with register renaming for updating the superforwarding table, according to various embodiments of the invention.

FIG. 6 depicts a block diagram of a superforwarding system with register renaming for modifying instructions, according to various embodiments of the invention.

FIG. 7 illustrates a method of modifying instructions according to various embodiments of the invention.

FIG. 8 depicts an exemplary diagram of a superforwarding system with register renaming, according to various embodiments of the invention.

Features and advantages of the invention will become more apparent from the detailed description of embodiments of the invention set forth below when taken in conjunction with the drawings in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description of embodiments of the invention refers to the accompanying drawings that illustrate exemplary embodiments. Embodiments described herein relate to a low power multiprocessor. Other embodiments are possible, and modifications can be made to the embodiments within the spirit and scope of this description. Therefore, the detailed description is not meant to limit the embodiments described below.

It should be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

An embodiment relates to identifying register-to-register (RtR) transfer instructions and eliminating the latency caused by RtR transfer instructions by forwarding the source information of the RtR transfer instruction to instructions using the destinations of the RtR transfer instructions. There are many types of RtR transfer instructions. For example, some instructions are always RtR transfer instructions, such as move “move” and “copy” instructions. In another example, some instructions are identified by the processor as RtR transfer instructions. These instructions include “add” and subtract “sub” instructions where one of the operands is 0x0. Further, shift left and shift right ins ructions can be RtR transfer instructions when one of the operands is 0x0, and multiply “mul” and divide “div” instructions when one of the operands is 0x1. These are just example instructions, and a person skilled in the art would understand that other instructions that result in the value of one register being copied to another register could also be identified as RtR transfer instructions.

FIG. 1 illustrates a block diagram of a general superforwarding system 100 for updating a superforwarding table, according to various embodiments. In an embodiment, general superforwarding system 100 includes a computation engine 102 and superforwarding table 104. In an embodiment, computation engine 102 executes instructions retrieved from memory.

In an embodiment, superforwarding table 104 stores one or more entries. Each entry includes a valid bit, a key field, and a forward field. The valid bit indicates whether this entry is valid or invalid, for example a value of “1” can indicate that the entry is valid and a value of “0” can indicate that the entry is invalid. When general superforwarding system 100 initializes superforwarding table 104, it clears all valid bits in superforwarding table 104 to indicate that all entries are invalid. The key field holds the destination address of RtR transfer instructions. The forward field holds the source address of the RtR transfer instruction. As an example, how a “move R3, R4” instruction, that copies the value of R4 into R3, is stored is described as follows. R4 (the source register) will be stored into the forward field of an entry. R3 (the destination register) will be stored into the key field of the entry. The valid bit for that entry will also be set, indicating that the entry contains valid information.

A person skilled in the art would understand that, where superforwarding table 104 includes more than one entry, there are multiple ways to update the superforwarding table 104, for example, by allocating a new entry for an RtR instruction if there are unused entries. Where all the entries have been allocated, various replacement policies and algorithms can be utilized to manage the entries in the table, such as LRU (least recently used), LFU (least frequently used).

In an embodiment, the RtR transfer instruction can proceed through computation engine 102 at the same time as the source and destination registers are stored in superforwarding table 104.

FIG. 2 illustrates a block diagram of a general superforwarding system 200 for modifying instructions, according to various embodiments. In an embodiment, general superforwarding system 200 includes a computation engine 102, a superforwarding table 104 and a super forwarding logic 206. Computation engine 102 and superforwarding table 104 are described above.

In an embodiment, superforwarding table 104 provides the valid bit, key field, and forwarding field information to super forwarding logic 206.

In an embodiment, when an instruction arrives, a source register address is sent to superforwarding logic 206. Superforwarding logic 206 compares the value of the source register against a register value stored in the key field for all valid entries. If there is a match, the instruction will be modified to use the register value stored in the forward field for the entry where there was a match. Expanding, on the above example, if, after the “move” instruction, the processor sees “add R2, R3, 0x08” that adds 8 to the value stored R3 and stores the result in R2, then superforwarding logic 206 will compare R3 (the source of the “add” instruction) with R3 (the destination of the “move” instruction stored in the key field). Because these match, the add instruction will be modified to be “add R2, R4, 0x08.” This will remove any dependencies this instruction has on the preceding RtR transfer instruction. In the example above, the add instruction is no longer dependent on the results of the “move” instruction, but instead is dependent on the results of the instruction that calculated R4. Thus, the processor can reduce or eliminate any latency associated with the execution of the RtR transfer instruction.

While the description above addresses the case where only one source register is handled by superforwarding unit 200, a person skilled in the art would recognize that this type of logic could be copied so that each source register for an instruction with more than one source register could be handled in parallel. Other implementations are possible for example serially checking each source register, depending on design constraints.

FIG. 3 is a flowchart for an embodiment illustrating how superforwarding logic works, for example superforwarding unit 200. At step 302, the superforwarding logic, e.g., superforwarding logic 206 described above, compares the source register of a received instruction against the information in the superforwarding table, e.g., superforwarding table 104 described above.

At step 304, the superforwarding logic determines if there is a hit in the superforwarding table, for example if there was a match between the source register and any entry in the superforwarding table. If there was no hit, then the superforwarding unit continues to step 308 and continues executing the received instruction without modification. If there was a hit, then the superforwarding, unit continues to step 306.

At step 306, the superforwarding logic determines the superforwarding register, for example, the register stored in the forward field of the entry that matched the source register. Once the superforwarding register is determined, continue to step 310.

At step 310, the superforwarding unit uses the superforwarding, register to modify the received instruction, replacing the source register with the determined superforwarding register, and continuing execution of the instruction at step 308. As discussed above, this modifies the dependencies of the instruction so that any latency associated with an RtR instruction is reduced or eliminated.

FIG. 4 illustrates an exemplary diagram of a gene al superforwarding system 400, according to various embodiments of the invention.

First, an RtR transfer instruction arrives that populates the entry of superforwarding table 504 that will be used later. The valid bit is set. The destination register value is stored in the key field and the source register value is stored in the forward field.

When a future instruction is received the source register is sent to superforwarding system 400. The source register of the future instruction is compared with the register in the key field of an entry in superforwarding table 104. At the same time, the source register is sent to multiplexer 414. Multiplexer 414 also receives the contents of the forward field, where the register in the key field matched the source register of the future instructions.

The select line of multiplexer 414, which selects between a register in the forward field and the source register depends on the values of the valid bit (to make sure we only use valid entries from superforwarding table), the results of the comparison (to make sure we only modify instructions where the source register of the future instruction is the same as the destination register of a previous RtR transfer instruction), and an enable bypass (which allows the system to turn on or off superforwarding). If each of these values is correct (a “1” in the embodiment illustrated), then the future instruction is modified to use the register stored in the forwards field of superforwarding table. If not, then the future instruction uses the source register of the future instruction.

FIG. 5 illustrates a block diagram of a superforwarding system 500 with register renaming for updating the superforwarding table, according to various embodiments of the invention. This embodiment is similar to the embodiment illustrated in FIG. 1, but includes access to register renaming table 506 prior to updating superforwarding table 504.

In an embodiment, register renaming table 506 maps architectural registers to physical registers. This permits systems to allow some registers, e.g., 32 architectural registers R0-R31, to be visible to the programmer, but allows the system to use more physical registers, or different physical registers, internally, e.g., 256 physical registers P0-P255. When an RtR transfer instruction is received, it is first sent to register renaming table 506. Register renaming table 506 allocates an available physical register to the destination architectural register of the RtR instruction. In addition, it sends the physical register associated with the source register of the RtR instruction to superforwarding table 504.

In an example, the instruction “move R2, R3” is received. This instruction transfers the value of R3 (the source register) into R2 (the destination register), and thus this is an RtR transfer instruction. The register renaming table will allocate an unused physical register to the destination register, for example P10. It will also send the physical register associated with R3 (the source register) to a new entry in the superforwarding table. This is illustrated below:

| Architectural | Physical | |
|---|---|---|
| Register | Register | |
| R0 | | |
| R1 | | |
| R2 | X −> P10 | |
| R3 | P15 | → Superforwarding table (to be stored in the forward field) |
| R4 | | |

Superforwarding table 504 is similar to superforwarding table 104, described above, except that it stores a physical register in each forwarding field rather than an architectural register. Therefore, each entry in superforwarding table 504 stores a valid bit, an architectural register address in the key field, and a physical register address in the forward field. As will be described below, this modification helps the ease of implementation and improve circuit performance on processors where register renaming is used.

FIG. 6 illustrates a block diagram of a superforwarding system 600 with register renaming for modifying instructions, according to various embodiments of the invention. A person skilled in the art would recognize that this is one implementation, and that other implementations are possible. For example, register renaming could be accomplished after the superforwarding logic.

As illustrated in FIG. 6, an instruction is received by superforwarding system 600. In an embodiment, the source register for that instruction is sent to both superforwarding logic, for example superforwarding logic 608, and a register renaming table, for example register renaming table 506. The register renaming table functions substantially the same as the register renaming table described with respect to FIG. 5.

The source register value for the instruction is sent to superforwarding logic 608. As described above with regard to superforwarding logic 206, superforwarding logic 608 compares the value of the source register against the valid keys in superforwarding table 504. As this comparison is happening, the register renaming table determines the physical register address associated with the source register (architectural) that this instruction uses. Once determined, the contents of the physical register are also sent to the superforwarding logic.

In an embodiment, superforwarding logic 608 functions similarly to superforwarding logic 206 described above. The main difference is that instead of choosing between two architectural registers, based on the contents of superforwarding table 504, superforwarding logic 608 chooses between two physical registers, one stored in the forward field of superforwarding table 504 and the received from the register rename table 506.

A person skilled in the art would realize that checking the superforwarding table for a match and determining the physical register associated with the source architectural register are both time intensive functions. By designing the system as described above, and illustrated below with regard to FIG. 8, these two time intensive procedures can be executed in parallel, allowing for additional performance improvement. A person skilled in the art would realize that other configurations are possible and still within the teachings of this disclosure and may be preferable, depending on design considerations.

A person skilled in the art would understand that in the embodiments described above, the basic register renaming functionality remains unchanged. In addition, physical register allocation and deallocation/recovery logic remains unchanged.

A person skilled in the art would also understand that the embodiments described above provide advantages over other designs where the register rename table is modified when an RtR transfer instruction is received. For example, if the register rename table is modified, and the computation engine needs to be flushed, for example if there is a branch mispredict, complicated logic needs to be implements to undo the modifications. For the embodiments described above, if there is a branch mispredict, all superforwarding unit 600 would need to do is to invalidate all the entries in superforwarding table 504, thereby undoing all changes made along the mispredicted path.

FIG. 7 illustrates a method of modifying instructions, according to various embodiments of the invention. After receiving an instruction source register, a physical register associated with that source register is retrieved at step 702. This can be accomplished by looking up the source register address in a register renaming table, for example register renaming table 506 described above.

At step 704, the source register is also used to check the superforwarding table. For example, the value of the source register can be compared to each key in each valid entry of a superforwarding table, for example superforwarding table 504, described above.

At step 708, the method determines if there was a hit within the superforwarding table. If there was a hit, the method continues on to step 710. If not, then the method continues on to step 706.

At step 706, because there was no valid match in the superforwarding table, the physical register that was determined in step 702 is used for this instruction, and execution continues in step 712.

As step 710, the method modifies the instruction to use the data in the forward field of the entry that resulted in a hit. As described above, a physical register is stored in the forwarding field of each entry in the superforwarding table. The instruction is modified to use the physical register stored in the selected entry of the superforwarding table, rather than the physical register associated with the source register. After this step is complete, execution continues with the modified instruction at step 712.

FIG. 8 illustrates an exemplary diagram of a superforwarding system 800 with register renaming, according to various embodiments of the invention. In this exemplary diagram, checking the superforwarding table and determining the physical register associates with the source architectural register happen substantially concurrently.

First, an RtR transfer instruction arrives that populates the entry of superforwarding table 504 that will be used later. The valid bit is set and the destination architectural register is stored in the key field. A physical register associated with the source architectural register is determined using register renaming table 506, described above with respect to FIG. 5. This physical register is stored in the forward field.

When a future instruction is received the source register is sent to superforwarding system 800. The source register of the future instruction is compared with the register in the key field of an entry in superforwarding table 504. At the same time, the source register of the future instruction is also sent to register rename table 506. Register rename table 506 determines the physical register associated with the source register and sends that the contents of the physical register to multiplexer 814. Multiplexer 814 also receives the contents of the physical register stored in a forward field, where the register in the key field matched the source register of the future instructions.

The select line of multiplexer 814, which selects between a register in the forward field and the register identified from register rename table 506 depends on the values of the valid bit (to make sure we only use valid entries from superforwarding table), the results of the comparison (to make sure we only modify instructions where the source register of the future instruction is the same as the destination register of a previous RtR transfer instruction), and an enable bypass (which allows the system to turn on or off superforwarding). If each of these values is correct (a “1” in the embodiment illustrated), then the future instruction is modified to use the register stored in the forwards field of superforwarding table. If not, then the future instruction uses the physical register associated with its soiree register.

While various embodiments have been described above, it should be understood that they have been presented by way of example, and not limitation. It will be apparent to persons skilled in the relevant computer arts that various changes in form and detail can be made therein without departing from the spirit and scope of the invention. Furthermore, it should be appreciated that the detailed description of the present invention provided herein, and not the summary and abstract sections, is intended to be used to interpret the claims. The summary and abstract sections may set forth one or more but not all exemplary embodiments of the present invention as contemplated by the inventors.

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL) and so on, or other available programs, databases, and/or circuit (e.g., schematic) capture tools. Embodiments can be disposed in any known non-transitory computer usable medium including semiconductor, magnetic disk, optical disk (e.g., CD-ROM, DVD-ROM, etc.).

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalence. It will be appreciated that embodiments using a combination of hardware and software may be implemented or facilitated by or in cooperation with hardware components enabling the functionality of the various software routines, modules, elements, or instructions, e.g., the components noted above with respect to FIGS. 1, 2, 4, 5, 6, and 8.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method comprising:
comparing a value of a source register for an instruction against a key for each valid entry in a superforwarding table; and
modifying the instruction by replacing the value of the source register with a value in a forward field if the source register matches the key for a valid entry in the superforwarding table.

2. The method of claim 1, further comprising:
identifying a register-to-register (RtR) transfer instruction, wherein the RtR transfer instruction transfers a value of a RtR source register to a RtR destination register; and
updating an entry in the superforwarding table by setting a valid bit, storing the RtR destination register into the key field, and storing the RtR source register into the forward field.

3. The method of claim 2, wherein storing the RtR source register comprises looking up the RtR source register in a register rename table to determine an associated RtR source physical register, wherein storing the RtR source register comprises storing contents of the RtR source physical register into the forward field.

4. The method of claim 1, further comprising:
looking up the source register in a register rename table to determine an associated source physical register; and
modifying the instruction by replacing the source register with the associated source physical register if the source register does not match the key for any valid entry in the superforwarding table.

5. The method of claim 1 wherein the comparing compares each source register of the instruction.

6. A processor comprising:
a superforwarding table configured to store an entry, wherein the entry has a valid bit, a key, and a forward field;
a superforwarding logic block, in communication with the superforwarding table, configured to determine if an instruction can use information in the forward field; and
a computation engine, in communication with the superforwarding logic block, configured to execute instructions.

7. The processor of claim 6, wherein the superforwarding table is further configured to store one or more additional entries.

8. The processor of claim 6, wherein the superforwarding logic block is further configured to determine if the instruction uses the results of a register-to-register (RtR) transfer instruction, and if so, modify the instruction to use an architectural source of the RtR transfer instruction.

9. The processor of claim 6, further comprising a register rename block, in communication with the superforwarding table and the superforwarding logic block, configured to map each architectural register to a physical register.

10. The processor of claim 9, wherein the register rename block is configured to provide the superforwarding table with a physical RtR source register associated with an architectural source register of an RtR transfer instruction.

11. The processor of claim 9, wherein the register rename block is configured to identify a physical source register associated with an architectural source register of the instruction.

12. The processor of claim 11, wherein the superforwarding table is configured to determine if the architectural source register matches the key in a valid entry of the superforwarding table.

13. The processor of claim 12, wherein the superforwarding table is configured to identify an associated physical RtR source register stored in the forward field concurrently with the register rename block identifying the physical source register.

14. A non-transitory computer readable storage medium having encoded thereon computer readable program code for generating a computer processor comprising:
a superforwarding table configured to store an entry, wherein the entry has a valid bit, a key, and a forward field;
a superforwarding logic block, in communication with the superforwarding table, configured to determine which register contains the information needed for an instruction; and
a computation engine, in communication with the superforwarding logic block, configured to execute instructions.

15. The non-transitory computer readable storage medium having encoded thereon computer readable program code for generating a computer processor of claim 14, wherein the superforwarding logic block is further configured to determine if the instruction uses the results of a register-to-register (RtR) transfer instruction, and if so, modify the instruction to use an architectural source of the RtR transfer instruction.

16. The non-transitory computer readable storage medium having encoded thereon computer readable program code for generating a computer processor of claim 14, further comprising a register rename block, in communication with the superforwarding table and the superforwarding logic block, configured to map each architectural register to a physical register.

17. The non-transitory computer readable storage medium having encoded thereon computer readable program code for generating a computer processor of claim 16, wherein the register rename block is configured to provide the superforwarding table with a physical RtR source register associated with an architectural source register of an RtR transfer instruction.

18. The non-transitory computer readable storage medium having encoded thereon computer readable program code for generating a computer processor of claim 16, wherein the register rename block is configured to identify a physical source register associated with an architectural source register of the instruction.

19. The non-transitory computer readable storage medium having encoded thereon computer readable program code for generating a computer processor of claim 18, wherein the superforwarding table is configured to determine if the architectural source register matches the key in a valid entry of the superforwarding table.

20. The non-transitory computer readable storage medium having encoded thereon computer readable program code for generating a computer processor of claim 19, wherein the superforwarding table is configured to identify an associated physical RtR source register stored in the forward field concurrently with the register rename block identifying the physical source register.
